(19) United States
(12) Patent Application Publication
(10) Pub. No.: US 2009/0180854 A1
(43) Pub. Date: Jul. 16, 2009

(54) Device to assist in removing cargo from a vehicle

(75) Inventor: Robert R. Hicks, (US)

Correspondence Address: STEVEN MELENDEZ (ASSIGNEE-PART), 9 MEADOWOOD COURT, HUNTINGTON, NY, 11743, US

(73) Assignees: STEVEN MELENDEZ, HUNTINGTON, NY (US); HELENE MENZELA (HENENE A. MENZELLA)

(21) Appl. No.: 12/007,486

(22) Filed: Jan. 11, 2008

(51) Int. Cl. B60P 1/32

(52) U.S. Cl. 414/539

(57) ABSTRACT

The subject device set forth herein is an improved apparatus to be deployed and used with a vehicle or other means used to transport cargo items from place to place, said device comprising means to move cargo from the vehicle by mechanically movable means which embrace or physically contact the cargo items in a thrusting movement to push against and move such cargo from the vehicle to a designated position away from the vehicle.

### DISCUSSION OF PRIOR ART AND BACKGROUND

The general field of relevant prior art generally involves mechanical means utilized to assist in the process of removing cargo items from a transport vehicle of any type. The more specific focus is directed to hand maneuvered trucks, such as the type commonly referred to as a dolly that is adapted for transporting through manual maneuvering box-like containers or other cargo items from place to place. The relative function of such dolly trucks is to hold such containers or similar objects in a relatively secure position to transport the cargo items from one location to another given location. Once so transported, the cargo items are then removed from the dolly.

Common examples of such usage of a dolly includes delivering canned or bottled beverages held in a box like container to a retail store. Such usage generally involves removal of the box-like container or other items from an over-the road truck outside a store, and placing the container on the dolly cargo platform and then pushing or pulling the dolly into the store. Once in the store or other intended location, the dolly operator must manually remove the containers or cargo items from the dolly platform by bending over and physically picking up the container and placing it at the intended location, or alternately tilting the dolly to allow cargo to slide off the dolly. These manual physical aspects tend not only to be time consuming and physically exhausting, but can be a contributing factor to work place injuries in such circumstances.

Many of these indicated problems, including logistical needs and physical aspects of removing cargo from large trucks, involve the same concerns or problems as set forth above. Therefore, the need for cargo removal assisting means extends beyond just the simple hand truck, and as result the general field of relevant art covers usage larger vehicles.

In this respect, it is also well known that when boxes or containers are placed in position for movement from one location to another, it is important that the boxes or containers be maintained and stabilized from moving or sliding around on the surface of the hand truck on which the container rests. The same applies to larger cargo carrying vehicles. This latter aspect is most important during the cargo transportation process, as containers holding fragile items may be jostled about during the transportation process and thereby be subjected to damage, and thus means are needed to stabilize containers in position, as well as to mean to remove the container with minimal impact. By reason of the manual effort needed to remove the containers from the hand truck or any truck, without damage to the container, there is a need under existing circumstances to reduce the manual effort, as the manual removal process frequently results in dropping the container on the floor, sometimes with significant impact

Another aspect of concern in this regard is that cardboard containers are generally susceptible to damage at the bottom corners or sides from mishandling of the container. When such corners are damaged, the integrity of the container may be compromised, and perishable products may be potentially at risk. Such potential damage can be alleviated by providing secure removal techniques and methods for such types of containers.

### SUMMARY OF INVENTION AND OBJECTS OF THE INVENTION

The subject device set forth herein is an improved apparatus to be deployed and used with a vehicle or other means used to transport cargo items from place to place, said device comprising means to move cargo from the vehicle by mechanically movable means which embrace or physically contact the cargo items in a thrusting movement to push against and move such cargo from the vehicle to a designated position away from the vehicle.

While, as stated above, the inventive concepts can apply to a broad range of cargo carrying vehicles, the subject invention as described herein is mainly directed to a hand push cart, known as a dolly. However such invention has potentially broader applications in cargo transporting and cargo removal enterprises.

In the present art status many hand pushed vehicles, such as a dolly, are adapted to have cargo placed thereon for movement from one location to another. Usually, these devices are structured in a manner that utilize a frontally projecting platform surface to temporarily hold cargo during transportation. There are several drawbacks and disadvantages to such known vehicles. One such disadvantage is that the cargo item must be removed from the dolly cargo platform by manual means, which often entails physical injuries or resultant danger to the item, as indicated above.

In view of the foregoing discussion and goals to minimize the physical lifting activity in removing cargo from a dolly or other vehicle, the following objects of the subject invention are directed to such end.

It is an object of the subject invention to provide an improved cargo removal apparatus for manually manipulated cargo carrying vehicles, such as a dolly;

It is another object of the subject invention to provide an improved cargo handling structure for manually manipulated cargo carrying vehicles;

Another object of the subject invention is to provide an improved cargo removal member for any type of cargo carrying vehicle;

Still another object of the subject invention is to provide an improved multipurpose cargo removal and movement member for cargo removal from a vehicle of any size or type;

Still another object of the subject invention is to provide an improved apparatus to transport a cargo item on a hand truck with mechanical assist means for removing a box or container from the truck;

Still another object of the subject invention is to provide an improved structural arrangement for holding or removing a cargo container or cargo item from a truck;

Yet another object of the subject invention is to provide a device to protect the integrity of the container when being transported or removed from a dolly or any type of truck;

A further object of the subject invention is to provide a structure for keeping a box or container intact during transportation and ultimate removal from a dolly or any type of vehicle;

An additional object of the subject of invention is to set forth means to maintain a container or cargo item from damage during removal from any type of vehicle;

Other and further objects of the subject invention will become apparent from a reading of the following description taken in conjunction with the claims and drawings herein.

### DRAWINGS

FIG. 1 is a front elevational view of a conventionally structured hand truck, known as a dolly;

FIG. 2 is a side elevational view of the conventional hand truck as shown in FIG. 1;

FIG. 3 is a side elevational view of a specific embodiment of a movable pushing member used to assist in cargo removal from a truck;

FIG. 4 is a side elevational view of a specific movable pushing member for a dolly, shown in FIG. 3, demonstrating the embodiment shown in FIG. 3 rotated forwardly over the cargo platform to assist mechanically in removal of the cargo off the platform of a hand truck, of the type shown in FIG. 1.

FIG. 5 is a top elevational view of the pushing member shown in FIG. 3

FIG. 6 is the side elevational view showing the rotatable pushing member in the retracted and inactive position on a hand truck;

FIG. 7 is a side elevational view of the dolly member demonstrating the rotatable pushing member rotated forwardly in the extended forward position from the retracted position shown in FIG. 6;

FIG. 8 is a side elevational view in cross-section demonstrating the dolly pushing member being activated by physical means such as a foot being placed on the top and upper rearward portion of the pushing member to cause it to rotate forwardly and against a cargo item shown on the cargo platform to initiate the cargo removal procedure;

FIG. 9 is the side elevational view of the same features shown in FIG. 8 which demonstrates how, when the foot is pushed downwardly to the full extent, the pushing member rotates and moves the forward plate of the pushing member against a cargo item on the cargo platform to complete the process of removing the cargo item from the platform.

FIG. 10 is a perspective view demonstrating complete movement of the cargo item off the cargo platform of the dolly as the frontal plate of the pushing member rotates forwardly to complete removal of the cargo item onto its intended place.

### DESCRIPTION OF GENERAL STRUCTURE OF THE SUBJECT INVENTION

In describing a general structural arrangement of the subject invention, it is to be noted that such general description shall not be considered as limiting the scope of the invention herein as set forth in the claims hereto, and thus a description of such a general description shall not be considered as limiting the concept of the subject invention to solely one type of vehicle;

This device set forth herein is a container holding and removing device conceived and structured as a means to help stabilize a box or other type of container member in an intended position on any kind of truck or vehicle, with secure mechanical means to remove containers or cargo from the vehicle, using mechanically structured means to minimize or eliminate the cumbersome manual efforts utilized in removing cargo items or objects from the truck or other similar vehicle. In general, appended to or associated with a truck, vehicle, or dolly will be a cargo removing device, which will have at least one mechanically movable appendage that can be embraced against a portion of the container or cargo object to effect removal thereof. The pushing device or other type of assisting device, can incorporate mechanical or other means, activated by mechanically leveraged manual effort, or by separate automated mechanically operating means requiring no manual effort, so as to thrust forward such pushing means against the container or cargo surface to move it off the cargo holding platform of the truck or vehicle.

In summary, the subject device is adapted to be placed adjacent or near the cargo holding platform on cargo handling vehicle. The additional function for such a device may also aid to keep the container or cargo from moving about or off the cargo platform on the vehicle during storage or transportation, however the main function is to provide means to mechanically move the cargo off and away from the cargo handling platform to keep the container from damage during removal stages.

In a larger perspective, the cargo removal assisting device is applicable to a full range of cargo carrying devices, as any such mechanical movement devices can minimize, in many circumstances, the usage of manual labor, lift truck usage and other relatively expensive means to remove cargo off a cargo carrying platform. Therefore, the subject device is not constrained simply to a dolly or hand manipulated truck, and thus may have wider applications, as more fully set forth herein.

### DESCRIPTION OF SPECIFIC EMBODIMENTS

In describing one or more specific embodiments of the subject invention, it is to be stressed that the following description of one or more specific embodiments shall not be considered as limiting the subject invention to just such described embodiments of the subject invention. Therefore, the following description shall not limit the scope of the invention herein as set forth in the claims. Moreover, as stated above, the subject invention is applicable to all types of cargo carrying vehicles or other cargo carrying means.

The device set forth herein is therefore conceived as a cargo holding and removing device structured as a means to stabilize a box or other type of container member in its intended position on any kind of truck or vehicle with means to remove such containers or other cargo items by mechanically structured means, or other types of removal means. The purpose, in this respect, is to alleviate or eliminate the cumbersome manual efforts utilized in removing objects from the truck or other similar vehicle. Most generally, a truck deployed with such a pushing device has at least one mechanically movable appendage that can be positioned and structured to be embraced against a portion of the container or cargo object to be removed. The pushing device incorporates mechanical or other means, structured to be movable with leveraged manual or automated mechanically operating means requiring no substantially manual effort, so as to be forced forwardly against the container or cargo surface to move the cargo off the holding platform of the truck. Means other than physical pushing efforts may be utilized in this respect to remove cargo items and structural methods other than pushing devices may be used in this respect.

Overall, the subject device is structured to be placed adjacent or near the cargo holding platform on a cargo handling vehicle. Such latter location is based on the supplementary function to ensure that the container will not move about during the transportation process and the primary function to mechanically move the cargo off and away from the cargo handling platform to protect the container from damage during removal stages.

Obviously, the cargo removal assisting device is applicable to a full range of cargo carrying devices, as any such described movement devices can lessen or mitigate aspects of the usage of manual labor, or minimize other relatively expensive means to remove cargo off a cargo carrying platform. Consequently, the subject device is not constrained simply to a dolly or hand manipulated truck, and thus may have wider applications to types of cargo carrying vehicles or means.

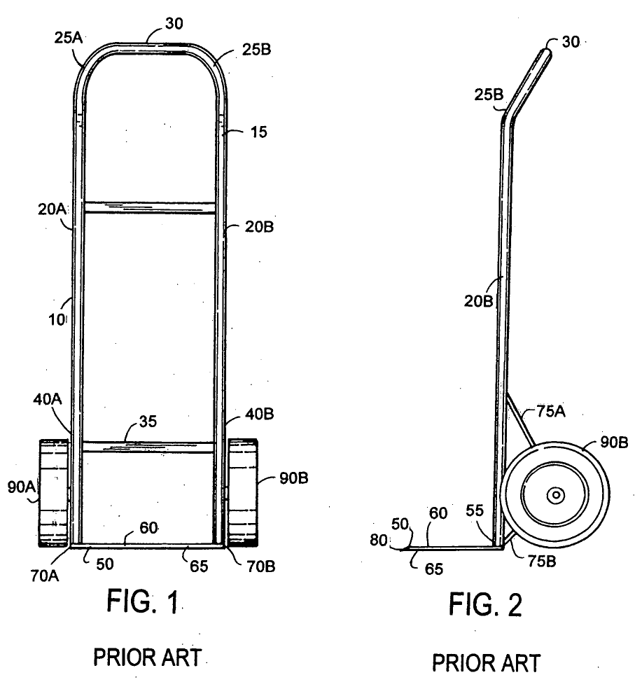

With this overall perspective, at hand, attention is addressed to a specific embodiment as focused on a dolly, but bearing in mind in this following specific description that the subject invention has extended other applications as discussed above. Accordingly attention is first addressed to FIGS. 1 and 2 of the drawings in which a hand pushed cargo carrying member referred to as a dolly 10 is shown. Dolly 10 is shown as a representative of a conventional cargo type carrying vehicle on which type the invention herein may be used. Graphically represented in FIG. 1, for overall perspective purposes, is such dolly member 10, hereinafter referred to as a “dolly” or “hand truck.” Dolly 10 is generally and basically structured on a rectangular configured frame 15, as seen in FIGS. 1 and 2. More directly, frame 15 is structured as a longitudinally extending rectangular frame member having vertically and longitudinally extending support aside bar members 20A and 20B. The upper portions 25A and 25 B respectively of such side bar members 20A and 20B are interconnected to an upper transverse bar member 30, which latter bar member 30 functions additionally as a handle member for manual maneuvering.

A lower transverse support bar 35 is joined and also forms part of the supporting frame 15 and the opposing ends thereof are joined to mid lower portions 40A and 40B respectively of the vertical support bar members 20A and 20B respectively, thereby completing the rectangular formation of the frame 15. The frame 15 has structured at or near the lower most portion of frame 15 a cargo holding platform 50 with the posterior edge 55 of the platform being generally affixed to the bottom most portions of the vertical supporting side bar members 20A and 20B as shown in FIGS. 1 and 2. The cargo holding platform 50 projects forwardly from the frame 15 in a substantially perpendicular manner, and basically is a flat member having an upper surface 60 and a lower surface 65, with the upper surface adapted to hold cargo items or containers or boxes thereon. The cargo platform additionally has side edges 70A and 70B, as well as a frontal edge 85 and a rear edge 55, as discussed. While the platform 50 is seen in the drawings as having a rectangular upper surface, it can be of any configuration as adapted for particular types of cargo items. The upper surface 60 of platform 50, as formed as a rectangular surface is flat in the embodiments shown in FIGS. 1 and 2. In other embodiments the upper surface 60 may have a variable surface height which will add to potential variations for differing or unique use purposes. As stated, the platform 50 projects forwardly from frame 15, that is towards the front areas of dolly 10, with the areas behind the frame being referred to as “rearward” or “posterior.”

Formed on the lower rearward portion of dolly frame 15 are brace members 75A and 75B that project rearwardly from the vertical support bar member 20B on such frame 15 and each such brace member joins one another in an approximate right angled formation at their respective rearward ends to support a stub axle 80A or other axle member to rotatably support wheel member 90B. Opposing wheel member 90A, seen in FIG. 1, is affixed and supported from side support bar member 20A by similarly structured brace members, such as brace members 75A and 75B. Further wheel members 90A and 90B as affixed to frame 15 are aligned in a parallel manner by common axle or separate stub axle means. More specifically, each rotatable wheel member 90A and 90B is mounted to said longitudinal frame 15 in a manner that permits each such wheel member to rotate freely and independently of one another as set forth below. As stated, such wheel members 90A and 90B are structured and joined to such frame preferably as parallel members so that they are generally aligned for movement in the same direction, and as independently moving members. Alternately, the wheels 90A and 90B can be joined to a common fixed axle or a common rotatable axle.

Further, opposing wheel members 90A and 90B, are substantially upright wheel members which are aligned parallel relative to the front to back position of such dolly 10, and as stated, both such wheels are aligned for movement in the same direction. It is understood that the subject invention can have more than two wheels or potentially in some instances only one wheel or no wheels under certain circumstance. However, the optimal arrangement is to deploy two wheels 90A and 90B, as shown as opposing wheels, preferably but not critically, each ideally being of equal diameter and disposed on the bottom portion of such frame 15. As is obvious, the use of two such wheels 90A and 90B as aligned with one another with both such wheels preferably being of equal diameter, will help to provide stability of the vehicle 10 in an upright position with the bottom of the platform 50 resting in part on the floor, while either in a stationary upright position. In this regard, the object is to allow the user to hold the frame 15 in a substantially upright position while operating or maneuvering the vehicle, with the user pushing or pulling the vehicle. Dolly 10 may also potentially be usable in any given position and the concepts of this invention may be focused on other types of cargo carrying vehicles, as discussed above.

The subject apparatus is thus focused as a hand pushed wheeled member as described above, to carry cargo or containers from a truck or other vehicle or other location. It is noted that the structure of dolly 10 thusly described is of a conventional structural arrangement, however such hand truck may vary in structural configuration as needs indicate. The subject invention is adapted or retrofitted on such a conventionally structured dolly 10. Again, the type of vehicle described can be of any type and the invention is not limited to the type of cargo handling dolly described above with a cargo and weight bearing portion at or near the bottom portion of said vehicle. Therefore the inventive concepts herein can be applied to any type of cargo carrying vehicle. Moreover, no inventive concepts are claimed herein as to the dolly structure described thus far in this sub-section.

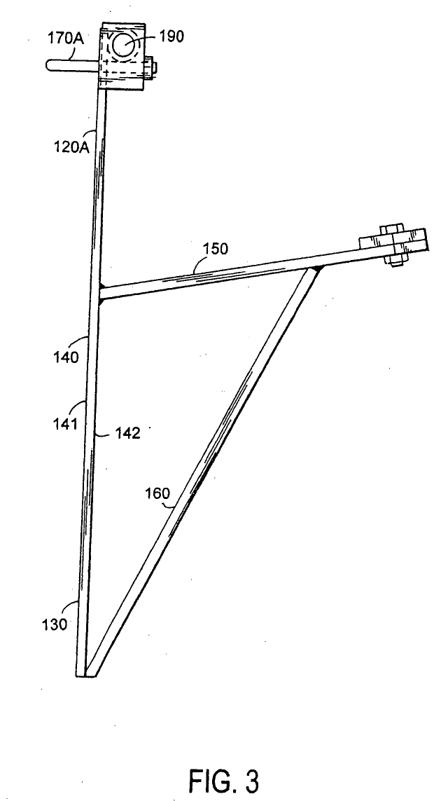

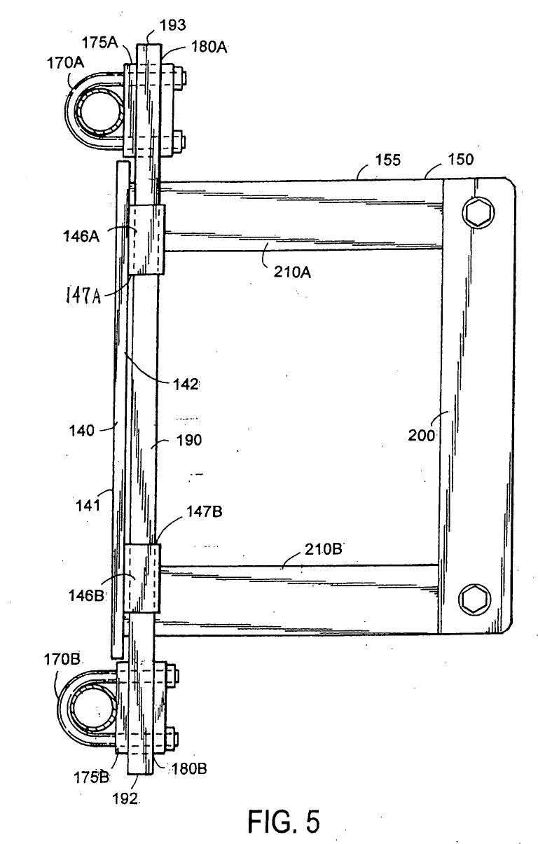

With this background at hand, reference is had to FIGS. 3, 4, 5,6,7,8,9, and 10 of the drawings. Shown in such drawings is one specific embodiment of the subject invention which is directed and centered on a movable cargo maneuvering or pushing member 100 incorporating features of the subject invention, as structured on a dolly, such as dolly 10. Consequently in describing this specific embodiment herein the structure of dolly 10 described above will be used as and described as a base for integrally holding the pushing member 100. In the larger breadth of the subject invention, the pushing device 100 is conceived as any type of physical device or apparatus or other means that can contact the cargo and thence push in some manner against the container or cargo item on the platform 50 of the dolly 10 so as to physically move the cargo off the platform 50 of dolly 10 towards the frontal edge of the dolly platform 50. Such pushing action needs to include sufficient movement distance and duration to completely remove the cargo item off of the upper surface 60 of the cargo platform 50 on dolly 10. Any physical, mechanical or other means can be used to move the cargo or container from the platform 50 of dolly 10, using other than an embraced pushing action, and it is stressed that the subject invention is not just limited to a pushing member to accomplish the purposes herein described. Therefore the following description of a particular structure for this purpose will not be considered as detracting from or obviating other embodiments falling within the above scope of the described generalized potential overall concepts or other such removal methods and structures.

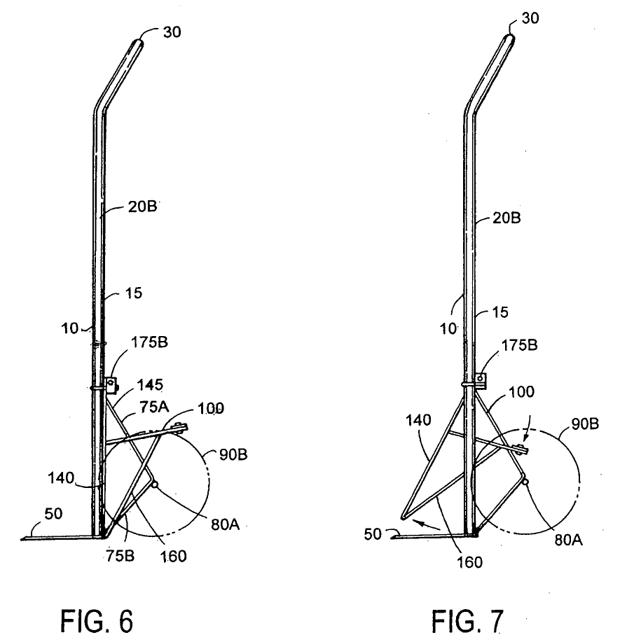

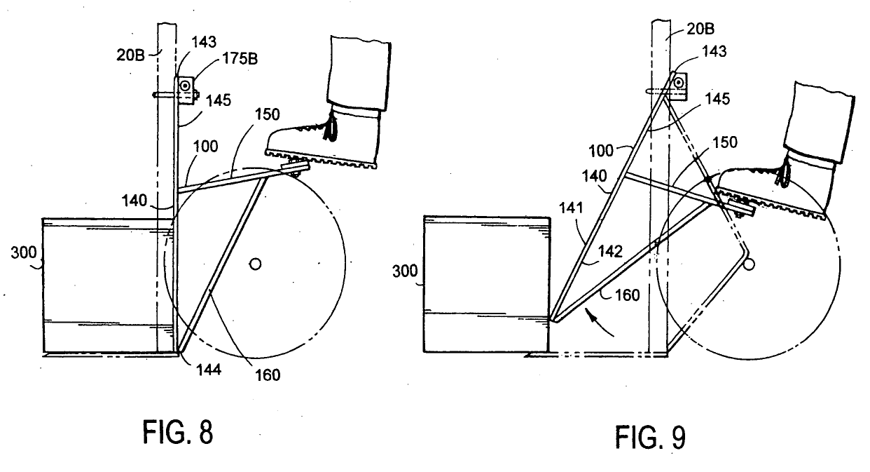

In this light, in the embodiment shown in FIGS. 3, 4, 5 and 6 of the drawing is a pushing member 100 comprised of a rotatable member 110 being rotatably mounted on frame 15 of dolly 10, as more fully discussed herein. Rotatable member 110 has an upper portion 120 and a lower portion 130, with such rotatable member being focused physically and mechanically on a frontially positioned solid plate member 140, rotatable from the upper portion thereof, as more fully described below. Rotatable plate member 140 is basically positioned in a vertical plane just behind the upper surface to the cargo platform 50, with the front facing towards platform 50 on dolly 10. Projecting rearwardly from the rear surface of the rotatable plate member 140 is a leveraged activating member 150, which when depressed by manual means or is otherwise pushed downwardly causes the plate member 140 to rotate towards the platform 50 and over the upper surface of the cargo platform 50 and swing forwardly over the upper surface of the cargo platform 50, as discussed in more detail below. The exact type of movement of the pushing member 100 can vary, however. The activating member 150, which projects rearwardly in a perpendicular manner from the posterior surface of the plate member 140, is shown in the drawings as being a rectangularly shaped open frame member 155, but can be formed as a rearwardly projecting bar member, or some other structural means adapted to receive the impact of a downwardly depressing force, such as downward foot pressure on frame 155 or other types of force or directional movement to activate the system herein. Moreover, automatic hydraulic or electromechanical means can be used to depress or move the activating member 150 downwardly. The particulars of this structural arrangement and process are more fully set forth below.

As stated and seen from the drawings the basic element or component of the pushing member is the rotatable plate member 140. Ideally the plate member 140 is formed of a durable metallic substance, such as steel or other substance. The plate member 140 is optimally formed as a rectangular member viewed frontally or from the rear position of dolly 10, but can be formed in any suitable configuration, and need not necessarily be of a rectangular configuration. Moreover the plate member 140 is formed with a frontal surface 141 and a posterior surface 142 and has an upper edge 143 a lower edge 144. Further, the plate member 140 has an upper portion 145 on the rear surface 142 of plate member 140 at or near the upper edge 143 of the posterior surface 142 of plate member 140. Affixed in a longitudinal manner to the upper portion 145 of the rear surface of plate member 140 are one or more longitudinally aligned sleeve members, such as sleeve members 146A and 146B, each having internal cylindrically shaped bores 147A and 147B respectly. Such latter bores 147A and 147B are aligned generally and preferably along a common longitudinally extending axis and are horizontally disposed and preferably parallel to the rear surface 142 of plate member 140. A longitudinally extending cylindrically bar member 190 is inserted in a longitudinally extending manner through such bores 147A and 147B in the sleeve members 146A and 146B with the opposing ends 192 and 193 of such bar extending outwardly beyond the sleeves 146A and 146B. The bar 190 as stated below is cylindrically shaped on the outer surface thereof. The bar 190 is thusly formed and sized so that the sleeve members 146A and 146B can rotate about bar 190, around in the inner bores 147A and 147B of such sleeve members.

Mounted on opposing positions on vertical support bar members 20A and 20B are clasping members 170A and 170B, which clasping members are formed as semicircular or horseshoe like members that are adapted to firmly embrace the frontal and side surfaces of the opposed support bar members 20A and 20B respectively. The clasping members 170A and 170B are shown as being mounted at a level just below the lower transverse support bar 35 and at the same horizontal level as the sleeve members 146A and 146B on the upper rear surface of plate member 140. Moreover, the clasping means 170A and 170B include on a posterior portion thereof solid locking members 175A and 175B respectfully to firmly lock the clasping members 170A and 170B in place over and partially around the surrounding circumferential surface of the respective support bar member 20A and 20B. As stated, each clasping member 170A and 170B has a rearwardly projecting solid locking portion 175A and 175B, with each solid locking portion 175A and 175B having a hollow cylindrical bore 180A and 180B respectively therein that extends longitudinally therethrough and basically parallel to the lower support bar 35 on frame 15. The opposing ends 192 and 193 of bar member 190 are inserted respectively into such bores 180A and 180B in a fixed manner so as to lock the bar 190 securely in non-rotatable and fixed horizontal position relative to the clasping members and otherwise. As stated above, the bar member 190 is cylindrically shaped on it outer surface thereof and inserted through the bores 147A and 147B in sleeves 146A and 146B on plate 140, which permits the sleeves 146A and 146B to be rotatable in the bores 147A and 147B about fixed bar member 190. Alternately stated the bar 190 is fixed and as positioned in bores 147A and 147B in the sleeves 146A and 146B, allows the sleeve to rotate about the fixed bar member 190, thereby permitting the plate member 140 to swing about a horizontal axis defined by the respective longitudinal axes of the bores members 147A and 147B. Since the sleeves 146A and 146B are affixed to the posterior 142 surface of plate 140, this indirect connection of the bar 190 through sleeves 146A and 146B is the only physical connection of plate 140 to the frame 15 of dolly 10. The plate member 140 will thus be also rotatable to a degree about the longitudinal axis of bar member 190.

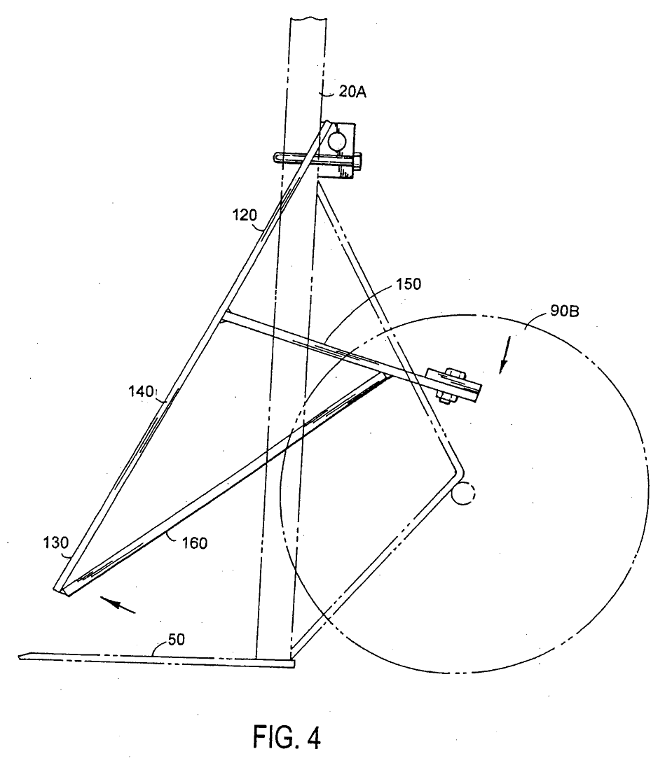

Consequently, the plate member 140 can rotate in a position from the vertical about the longitudinal axis of bar 190 and the bottom of the plate 140 will move in an arcuate movement from the such vertical position shown in FIG. 3 forwardly to the forward angular position shown in FIG. 4. When the plate 140 is not pushed forwardly from behind it will remain substantially vertical straight up and down as shown in FIG. 3, due to the gravity effect on the plate 140. Moreover, means can be appended to the frame 15 to keep the plate from swinging or rotating rearwardly, such as blocking members on the frame support member 20A and 20B to block the outer perimeter portion of the plate 140 from moving in a posterior movement relative to the frame 15.

Projecting rearwardly from the rear surface 142 of the in plate 140 as seen in the drawings, is the rectangular activating member 150 functioning as the activation member to rotate plate 140, and positioned to be approximately at a perpendicular relationship to the rear surface 142 of plate member 150. More particularly, the rearward protruding rectangular activation member 150 is shown as projecting rearwardly from surface 142 at an approximate right angled relationship from the mid upper portion of rear surface 142 of plate member 140. By noting that it is the most rearward portion of activation member 150 that is to be pressed downwardly to rotate the plate 140 forwardly, as shown, additional truss-like connection means 160 are needed to be joined from the rearward of portion of the activating member 150 to the lower rear surface 142 of plate 140, particularly toward the bottom portion of the plate 140. This additional truss-like connection member 160 is needed and affixed to provide additional vector force means extending from the back portion of the activating member 150 to translate vector forces to the lower part of the plate 140 by impinging against the lower part of plate for improved leverage to thrust the lower part of the plate forward in a rotational manner as more fully discussed below.

The activating member as shown is formed as a frame member 155 with posterior positioned longitudinally extending support member 200, and lateral side support members 210A and 210B which are affixed on the forward ends thereto to the back surface 142 of the plate member 140 to thereby affix the frame 155 to the plate 140. The upper surface of the support member 200 is adapted to receive the pressure of a downwardly pressed foot to push frame 155 downwardly to cause force to be imparted in a frontal direction to push plate 140 forwardly.

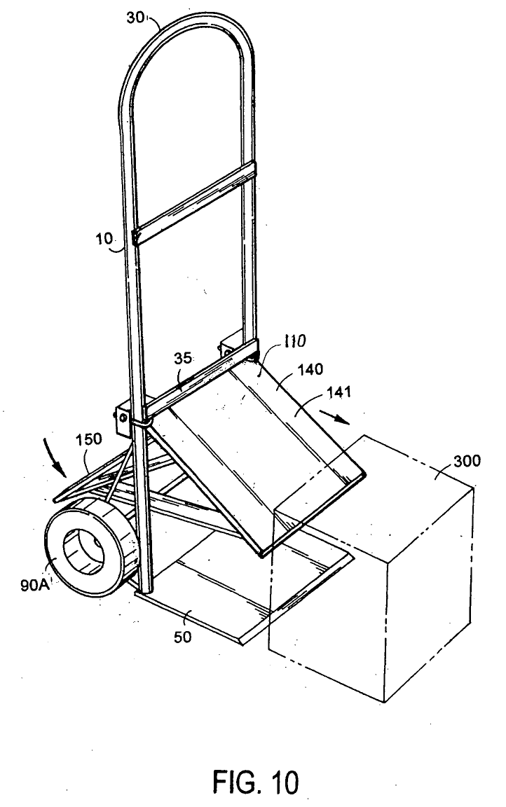

More directly, as seen in FIGS. 9 and 10 when the foot is pressed downwardly on the rear portion of frame 155 the downward pressure or force will be vectored primarily through truss member 160 directed to the rear lower surface portion of plate 140, thereby causing the plate 140 to rotate about hinge members 146A and 146B, as the vector forces are directed mainly to lower part of plate 140. The plate 140 then moves in an arcuate directional movement forwardly over the cargo platform 50 to contact the container 300 on said platform with the lower portion of the plate 140 impinging in a moving manner against the container 300 to move the container forwardly pushing the container off the platform, as seen in FIG. 10. As stated above the activating member can be moved by automatic means, in the form of any mechanical device.

In summary, the subject invention comprises a device for assisting in removing cargo from a cargo carrying platform on a truck comprising:
(a) a moveable plate member affixed to said truck including means adapted to move against said cargo on said platform and push said cargo off said platform

Further summarizing, the subject invention is a pushing member to move cargo off a platform on a cargo item moving vehicle comprising:
(a) a cargo movement member affixed to said vehicle;
(b) means to move said pushing member against said cargo item

Additionally summarizing, the subject invention is a cargo moving member having a cargo platform comprising:
(a) an a movable extension member disposed adjacent to said cargo platform
(b) means affixed to said moveable extension member to move said extension toward the cargo platform, and push against cargo on said platform so as to push cargo off said platform.

1. A device for assisting in removing cargo from a cargo carrying platform on a truck comprising:
(a) a movable plate member affixed to said truck with means attached to said device adapted to move said plate against said cargo on said platform and push said cargo off said platform.

2. A pushing member to move a cargo item off a cargo carrying platform on a cargo carrying vehicle comprising:
(a) a cargo pushing member affixed to said vehicle;
(b) means attached to said cargo movement member to move said cargo pushing member against said cargo item to move said cargo item off said cargo carrying platform.

3. A cargo removal member to remove cargo, said cargo removal member being affixed on a cargo carrying device, having a cargo carry surface, comprising:
(a) a movable extension member on said cargo carrying device and disposed adjacent to said cargo carrying surface;
(b) means affixed to said movable extension member to extend said extension member towards said cargo carrying surface, to push against said cargo item on said cargo carrying surface so as to push said cargo off said cargo carry surface;
(c) means to retract said movable extension member.
